(19) United States
(12) Patent Application Publication
(10) Pub. No.: US 2001/0045231 A1
(43) Pub. Date: Nov. 29, 2001

(54) Ball valve with replaceable cartridge insert

(76) Inventor: Gilles Monod, Clarafond (FR)

Correspondence Address: HOWSON AND HOWSON, ONE SPRING HOUSE CORPORATION CENTER, BOX 457, 321 NORRISTOWN ROAD, SPRING HOUSE, PA, 19477, US

(21) Appl. No.: 09/874,332

(22) Filed: Jun. 5, 2001

Related U.S. Application Data
(63) Continuation-in-part of application No. 09/332,431, filed on Jun. 14, 1999, now abandoned.

(51) Int. Cl. F16K 5/00

(52) U.S. Cl. 137/454.2; 251/315.13

(57) ABSTRACT

A ball valve includes a bonnet and a removable insert in which a valve ball and opposed seat rings are contained within a cartridge of separable shells. Cylindrical spring seals of resilient and impervious high density graphite or silicon ruber are mounted on a reduced diameter length of each seat ring. Other embodiments include annular coil springs which compensate for component wear, and contraction and expansion due to changes in temperature. The spring seals are compressed between shoulders on the seat rings and a facing annular recessed surfaces in the cartridge and urge the seat rings into dynamic sealing contact with the valve ball. The spring seals also provide static sealing at the interface of the seat rings and the cartridge. Connecting fittings on mating surfaces of the bonnet and the insert enable the insert to be completely removed from the valve body for easy access for repair or replacement of components within the cartridge.

### RELATED APPLICATION

This is a continuation-in-part application of application Ser. No. 09/332,431 filed Jun. 14, 1999.

### FIELD OF THE INVENTION

The present invention relates generally to ball valves, and more particularly to an improved valve construction having a valve body with a novel replaceable valve plug and cartridge insert which is particularly suitable for use under extreme conditions of temperature and pressure.

### BACKGROUND OF THE INVENTION

Many ball valves have removable covers or bonnets to permit access to the interior of the valve body for replacing defective or worn plugs and seals without having to dismantle the entire valve from a pipe line. U.S. Pat. No. 3,195,560 to Pofit discloses such a top entry ball valve in which a rotatable spherical plug is seated within the valve body between annular dynamic seat rings. The rings are urged against the plug by externally disposed springs acting between the rings and the valve body. With the valve cover removed, the plug must be extracted before the seat rings or the springs can be replaced. A modification of this design uses a cartridge type insert. The valve plug and seat rings are pre-assembled in a conical cartridge of two half shells. By this arrangement, the critical components can be easily installed as one unit in the valve body. For example, U.S. Pat. No. 2,885,179 to Hartmann shows a top entry ball valve in which the plug and seat rings are preassembled between two half shells to form a cylindrical cartridge which can be inserted in the valve body as one unit. The dynamic sealing effect obtains from resilient annular packings on opposite external sides of each seat ring compressed between the plug and the interior of the valve body. U.S. Pat. No. 5,135,019 to DuPont similarly discloses a top entry ball valve designed for use in deep water. The spherical plug and seat rings are preassembled within a tapered cartridge of two half shells for replacement in the valve body as a single cartridge insert. The seals are pressed against opposite external sides of the plug by dish-type spring washers and resilient static seals acting in series between the plug and the valve body. U.S. Pat. No. 4,587,990 to Pennell et al. discloses a top entry ball valve in which the spherical plug, seat rings and a plurality of spiral springs are preassembled within a tapered cartridge of half-shells for inserting in the valve body. The seat rings include a plurality of circumferentially spaced bores which receive the springs and act against the interior of the cartridge to urge the seat rings into sealed engagement with the plug. U.S. Pat. No. 4,796,858 to Kabel shows bottom entry valve in which a tapered inserts are disposed on opposite sides of a cylindrical plug

In each of these valves there are no springs which are completely contained within the cartridge insert and which serve as a positive seal as well. Rather, the spring elements must be installed external to the cartridge insert, or a plurality of springs must be pre-installed around each seat ring or insert before being inserted in the valve body.

### OBJECTS OF THE INVENTION

Accordingly, it is an object of the present invention to provide a novel ball valve construction in which the internal components are completely preassembled as an insertable cartridge for easy replacement or repair without dismantling the valve body from an installation, and in which unique spring seals are isolated from the valve body to maintain a positive dynamic seal.

Another object of the invention is to provide a readily replaceable plug and sealing mechanism in a ball valve construction in which the sealing force applied to the plug is independent of the valve body.

Still another object is to provide a ball valve insert in which the plug and spring sealing mechanisms are totally enclosed within an easily assembled cartridge.

A further object is to provide a ball valve construction in which internal components can be readily replaced without removing the valve body from a fluid line.

Another object is to provide a ball valve construction in which an insertable cartridge is retained by the valve bonnet during insertion and extraction from the valve body.

Still another object is to provide a complete and removable cartridge insert for a ball valve which can operate continuously under sustained conditions of high temperatures and pressures.

Yet another object of the invention is to provide a ball valve construction having a cartridge insert, with fully enclosed seal springs, which can be replaced or repaired without dismantling the valve actuating mechanism for the valve body.

### SUMMARY OF THE INVENTION

Briefly, these and other objects and novel aspects of the invention are accomplished by an insert for a ball valve body and bonnet in which a spherical valve plug and seat rings are assembled in a cartridge of mating shells.

In one embodiment, cylindrical spring seals of resilient and impervious high density graphite or silicon rubber, are mounted on a reduced diameter section of the seat rings between a shoulder on the seat rings and an annular recessed surface of the cartridge for urging the seat rings into sealing contact with the plug. The spring seals also provide a positive seal at the interface of the seat rings and the cartridge.

In other embodiments, push rings and annular coil springs are interposed between the graphite or rubber spring seals and the recessed surfaces of the cartridge to increase the spring and sealing effect of the spring seals. Connecting fittings on the mating surfaces of the valve bonnet and the insert enable the insert to be removed from the valve body while attached to the bonnet and valve actuating mechanism, and then disconnected for replacement of worn components. An alternative configuration allows the cartridge insert to be removed completely without dismantling the actuating mechanism from the bonnet or valve body.

### BRIEF DESCRIPTION OF THE DRAWINGS

For a better understand of the invention, reference will be made to the following detailed description taken in conjunction with the accompanying drawings wherein:

FIG. 1 represents a longitudinal sectional view of a ball valve according to the invention with a top entry removable cartridge insert in the open position;

FIG. 2 is a view in cross section of the ball valve taken along the line 2-2 of FIG.1;

FIG. 3 is an exploded perspective view of component parts of the ball valve of FIG. 1;

FIG. 4 is an enlarged view in cross section of a portion of the valve seat and seal spring of FIG. 2;

FIG. 5 is an enlarged view in cross section of a bonnet-cartridge connector in the ball valve taken along the line 5-5 of FIG. 1.

FIG. 6 is a view in cross section of the bonnet-cartridge connector taken along the line 6-6 of FIG. 5;

FIG. 7 is a view in cross section like FIG. 2 of an alternate bonnet-cartridge connector for the ball valve of FIG. 1 according to the invention.

FIG. 8 is a longitudinal view in cross section of another embodiment of a ball valve according to the invention with a top entry cartridge insert secured by a pull nut;

FIG. 9 is an enlarged view in cross section of a portion of the ball valve of FIG. 8;

FIG. 10 is an exploded view of component parts of the ball valve of FIG. 8.

FIG. 11 is an external view of another embodiment of a two-way ball valve according to the invention;

FIG. 12 is a cross sectional view of the ball valve of FIG. 11 taken along the line 12-12 thereof;

FIG. 13 is a cross sectional view of the ball valve of FIG. 11 taken along the line 13-13 of FIG. 12;

FIG. 14 is a view in longitudinal cross section of another embodiment of a ball valve according to the invention having a top entry cartridge insert with a composite spring seals;

FIG. 14A is an enlarged fragmentary section of a seal of FIG. 14;

FIG. 15 is a view of an alternate embodiment of the composite spring seal of FIG. 14A; and

FIG. 16 is a view in longitudinal cross section of another embodiment of a bottom entry ball valve according to the invention with a cartridge insert and composite spring seals.

### DESCRIPTION OF THE PREFERRED EMBODIMENTS

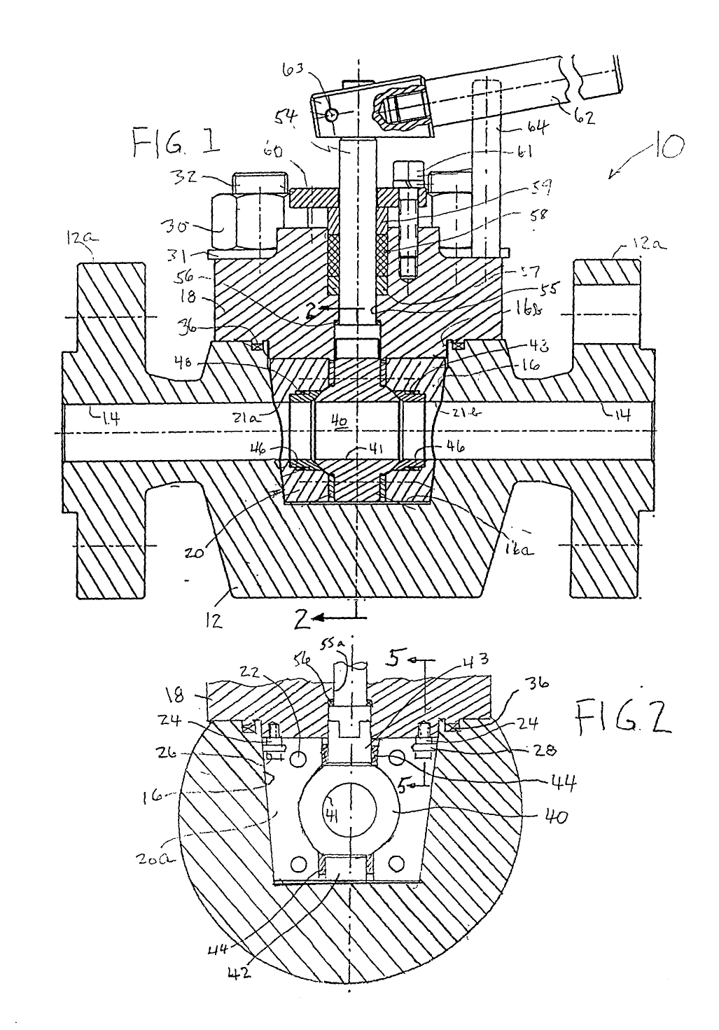

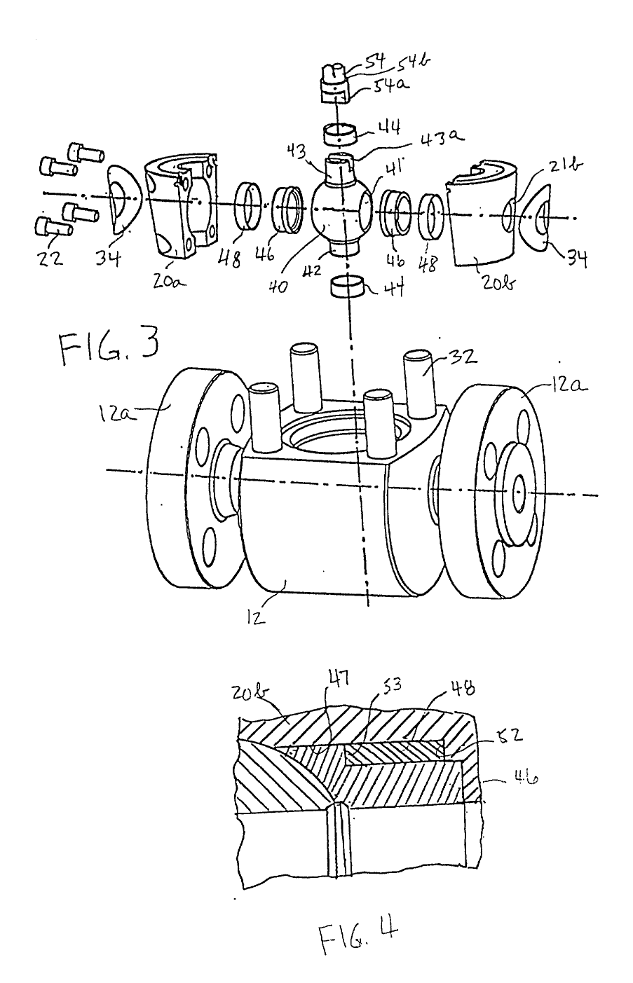

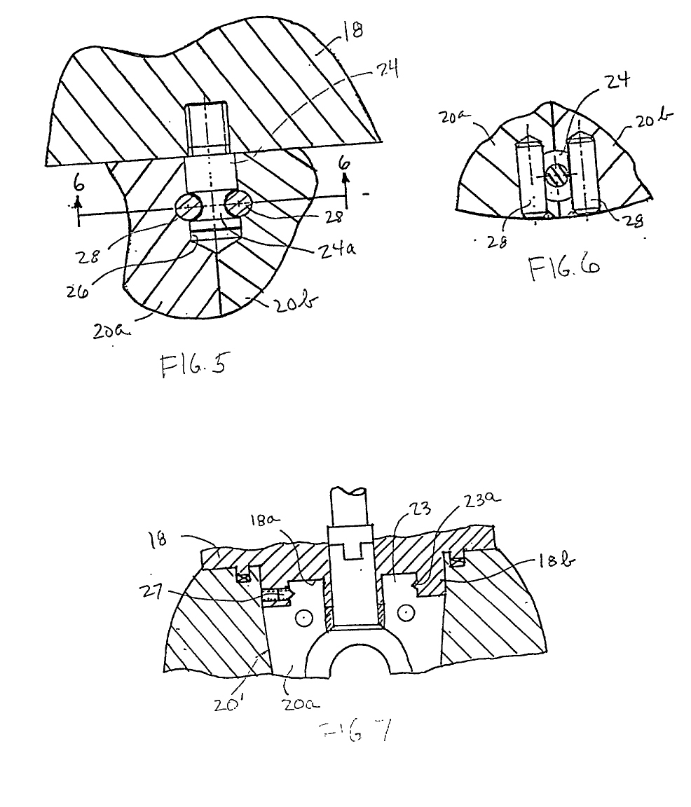

Referring now to the drawings, wherein like reference characters denote like or corresponding parts throughout the several views, FIGS. 1-6 represent one embodiment of a ball valve 10 comprising a valve body 12 with aligned inlet and outlet flow passages 14 terminating at opposite ends with flanges 12a for installing in a flow line. A frustoconical cavity 16 formed between the flow passages on a central axis normal thereto tapers outwardly from a blind end 16a to a top entry 16b formed to receive an insert including a cartridge insert 20 of two semicircular half-shells 20a and 20b joined together by fasteners 22 and retained in valve body 12 by a bonnet 18. Cartridge 20 forms an outer surface tapered to fit contiguously in cavity 16. Each half-shell 20a and 20b respectively includes a port 21a and 21b for communicating between the flow passages 14. Ports 21a and 21b are aligned with passages 14 by two studs 24 each threaded at one end into the base of bonnet 18 and the other end insertable into aligned blind holes 26 in the abutting faces of half-shells 20a and 20b. As best seen in FIGS. 5 and 6, each stud 24 is retained in a blind hole 26 by a pin 28 inserted through a respective half-shell 21a or 21b to engage opposite sides of a continuous groove 24a around the stud 24. Cartridge 20 is thereby concurrently removable with bonnet 18 from valve body 12, and separable from bonnet 18 upon removal of pins 28. Annular seals 34, bonded to the curved surfaces of cartridge 20 around ports 21a and 21b, prevent fluid in passages 14 from escaping through the interface of cartridge 20 and valve body 12.

Cartridge 20 houses a valve ball 40 with engaging surfaces 20c and lower and upper journals 42 and 43 for rotation in bushings 44 on an axis normal to the length of passages 14. A bore 41 through ball 40, preferably of the same diameter as passages 14, aligns with ports 21a and 21b when rotated 90 degrees from a closed position to a fully open position as shown.

As best seen in the portion of half-shell 20b shown in FIG. 4, each half-shell 20a and 20b has a valve seat ring 46, slidable in an annular recess 47 around port 21a and 21b, respectively. Surfaces 46a on rings 46 are urged axially against opposite sides of valve ball 40 by annular spring seals 48 which are axially compressed between shoulders 52 around recesses 47 and shoulders 53 around seats 46. Positive seals between valve ball 40, valve body 12 and seats 46 are thereby maintained independent of the position of cartridge 20 relative to and the wall of cavity 16. The material selected for seat rings 46 is preferably a metal composite suitable for use under extreme conditions of heat and chemical exposure such as duplex alloys and stainless or CrMo steels. Spring seals 48 are preferably made of a resilient and impervious material such as high density graphite or a silicone rubber for both resilience and sealing. A most preferred material is an elastically-compressible, expanded graphite having a precompressed density in a range of about 1.4 to about 2.2 g/cm³, and a compressed density in a range of about 0.9 to 1.2 g/cm³.

Bonnet 18, with cartridge 20 attached, is secured to the top of valve body 12 by nuts 30 and washers 31 threadingly tightened on four corner studs 32 to sealingly compress annular seals 34 and a ring gasket 36 between the interfaces of cartridge 20, valve body 12 and bonnet 18. A valve stem 54 extends through a bore 55 bonnet 18 and includes a key 54a interlocking with a mating slot 43a in upper journal 43 for transmitting rotation of stem 54 to valve ball 40. A thrust bearing 56 between a shoulder 54b on stem 54 and a shoulder in bore 55 sustains axial loading and restricts upward movement of stem 54. Conventional components such as stem seal 57, packing 58 and gland 59 are compressed against a shoulder of base 55 by a packing flange 60 and six bolts 61 (only one shown) threaded into the upper end of bonnet 18 to prevent leakage around stem 54.

A lever 62 pivotally connected to valve stem 54 by a pin 63 provides for manual opening and closing valve ball 40. A stop 64 extending from the top of bonnet 18 engages leaver 62 when bore 41 of valve ball 40 is in a fully open position aligned with passages 14.

As described, the components within cartridge 20 are preassembled for quick and easy replacement or repair of parts without dismantling valve body 12 from a pipe line. In assembly, valve ball 40, bushings 44, seats 46 and spring seals 48 are placed between half-shells 20a and 20b. As the shells are drawn together by fasteners 22, compression of spring seals 48 positively urges seals 46 against ball 40 creating a dynamic seal. With seals 34 bonded around each port 32, cartridge 20 is attached to bonnet 18 by studs 24 and pins 28 and then inserted into cavity 16. Stem 54, thrust bearing 56 and bonnet seal 36 are then secured in place with bonnet 18 secured to valve body 12 by nuts 30. Cartridge 20 and bonnet 18 are easily removed from valve body 12 as a single unit by removing nuts 30. Then cartridge 20 may be separated from bonnet 18 by removing pins 28 and disassembly by removing fasteners 22.

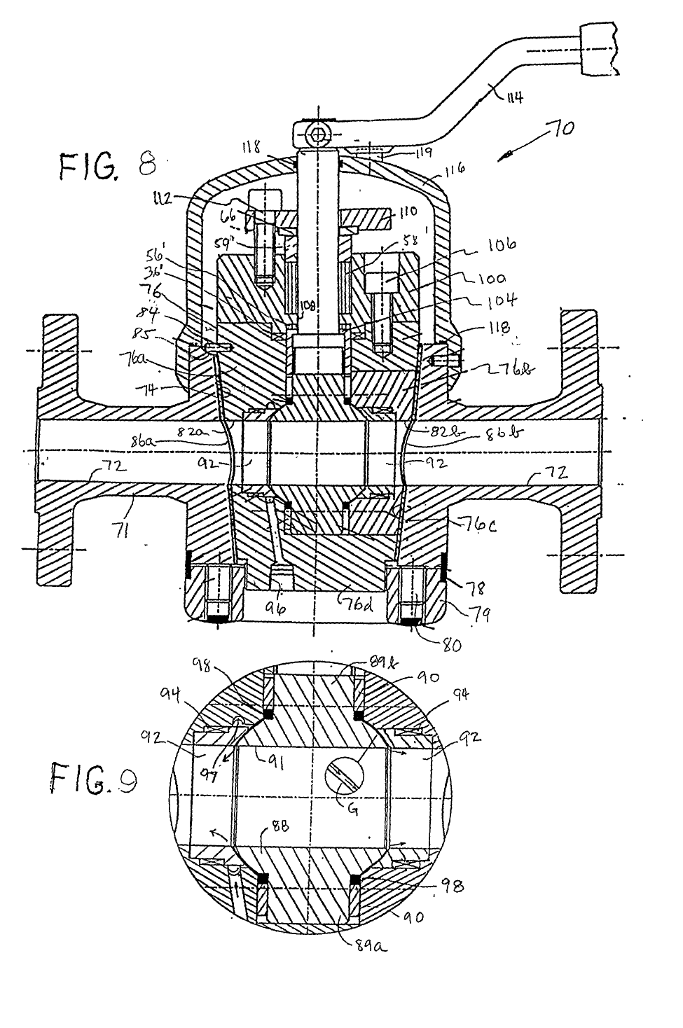

FIG. 7 shows an alternative means for securing a cartridge 20′ to bonnet 18′. The joined half-shells 20a ′ and 20b ′ form a round boss 23 insertable in a mating recess 18a of an annular extension 18b on the facing surface of bonnet 18. Set screws 27 spaced around extension 18b engage a peripheral groove 23a around boss 23 to secure cartridge 20′ to bonnet 18′.

FIGS. 8, 9 and 10 disclose another embodiment of a ball valve 70 which is particularly suitable for use in chemical and pharmaceutical processes. It comprises a valve body 71 with aligned inlet and outlet passages 72 communicating with a frusto-conical cavity 74 open at both ends and tapering outward toward the top opening 71a on a central axis normal to the length of passages 72. A cartridge 76, comprising a frustoconical shell 76a with a recess 76c intermediate its length, receives a semicircular shell 76b to form a continuous conical surface mating with the surface of cavity 74. With cartridge 76 fully inserted in cavity 74, a reduced diameter threaded end 76d of shell 76a extends through the bottom opening of cavity 74 and is secured by a gasket 78, pull nut 79 and screws 80.

Shells 76a and 76b include ports 82a and 82b which register with passages 72 by a guide pin 84 radially extending from the periphery of shell 76a and seated in a radial groove 85 in valve body 71. An annular static seal 86a bonded on the curved surface of shell 76a around port 82a seals the interface of cartridge 76 and valve body 71. Another static seal 86b, bonded to the curved surface around port 82b and overlapping the peripheral juncture of shells 76a and 76b provide seals at the interface of both shells 76a and 76b and valve body 71.

Like ball valve 10 of FIGS. 1-3, cartridge 76 and its installed components are completely removable from cavity 74 without the dismantling valve body 71 from a pipe line by removing pull nut 79. A valve ball 88 with lower and upper journals 89a and 89b are rotatably supported in bushings 90 within cartridge 76 on an axis normal to the flow path through inlet and outlet passages 72. A bore 91 through ball 88 preferably the same diameter as passages 72, align with ports 82a and 82b when rotated 90 degrees from a closed position to a fully open position as shown. Seat rings 92 and annular spring seats 94 are arranged in cartridge 76 like similar parts in valve 10 of FIG. 4 and act in the same manner to maintain a positive seal between ball 88 and seat 92 as well as a seal between seat rings 92 and said cartridge 76.

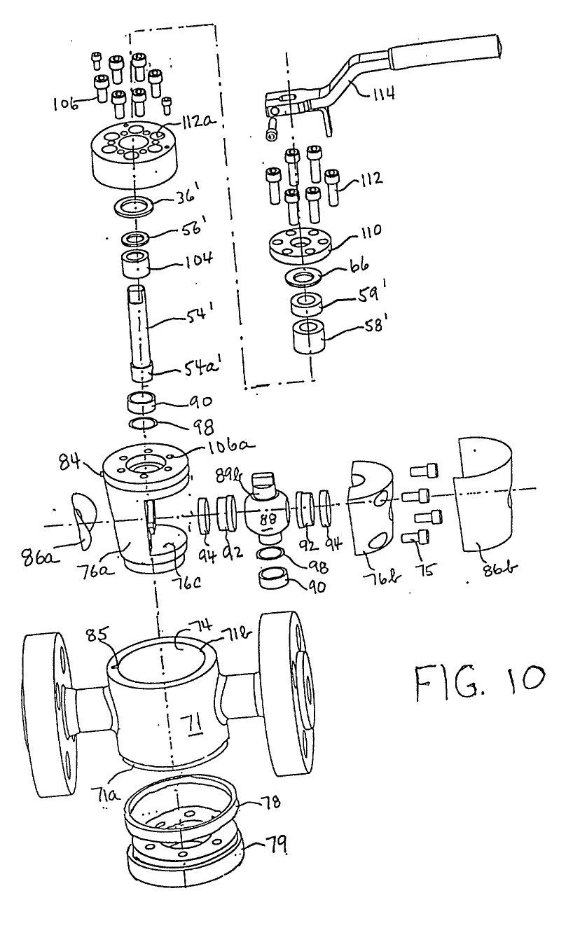

Purging the contacting surfaces of valve ball 88 and seat rings 92 of contaminants is provided by introducing a cleaning fluid such as steam under pressure through a conduit 96 to a channel 97 (FIG. 9) encircling one of seat rings 92 and communicating with the interface of both seat rings 92 and ball 88. The pressure causes the cleaning fluid to pass through the gaps G in the interfaces and discharge with purged matter into inlet and outlet passages 72. Seals 98 prevent the cleaning fluid from leaking past the interface of journals 89 and cartridge 76.

A bonnet 100 secures stem 54′, gasket 98, bushings 90, stem cap 104, thrust ring 56′ and ring gasket 36′ in place with six bolts 106 screwed into threaded holes 106a. (FIG. 10). Packing 58′, gland 59′ and spring washer 66 are compressed against an annular boss 108 by a packing flange 110 and six bolts 112 screw into threaded holes 112a. Valve ball 88 is manually rotated by an actuating lever 114. But for the upper end of stem 54′ ; the entire upper section of the ball valve 70 is insulated from ambient atmosphere by a cover 116, secured by set screws 117, and upper and lower seals 118. Valve ball 88 is manually rotated by an actuating lever 114 which is limited in rotation in the fully open position by a stop 119 extending from the top of cover 116.

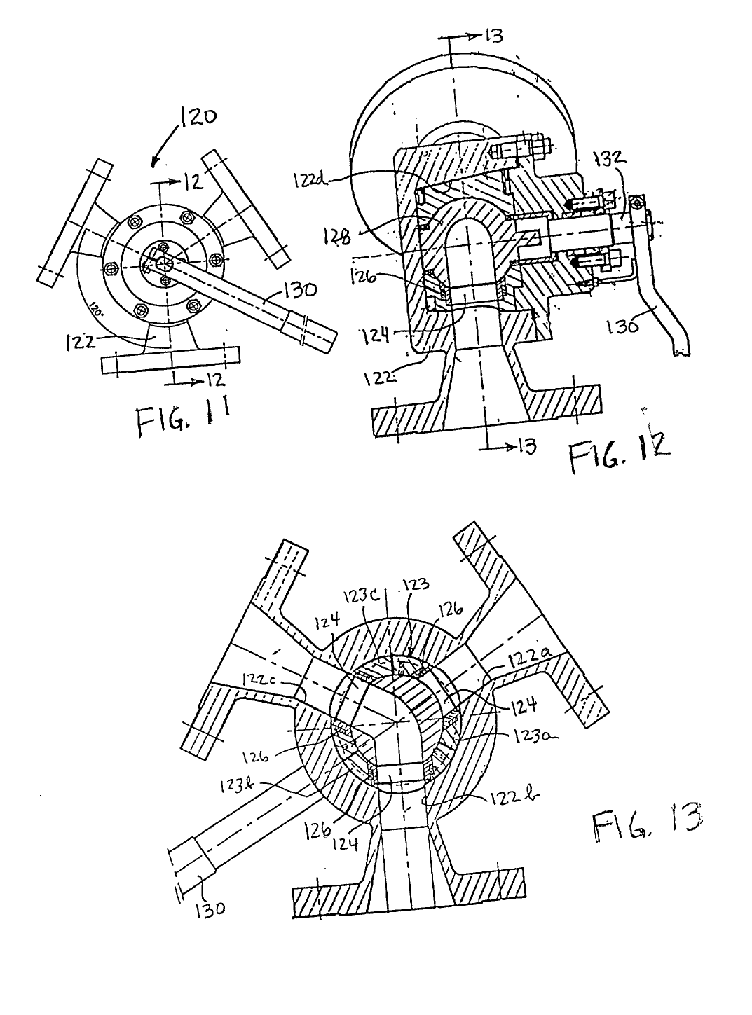

Referring now to FIGS. 11, 12, and 13, the inventive concept is shown applied to a two-way ball valve 120 having a valve body 122 with radially spaced ports 122a, b and c arranged along a single plane and communicating with a conical cavity 122d extending on an axis normal to the plane. Three arcuate segments 123a, b and c are joined to form a tapered cartridge 123 matching the shape of cavity 122d and inserted therein. Like half-shells 20a and 20b of FIGS. 1-3, each segment 123a, b and c has a valve seat ring 124 inserted in an annular recess, and an annular spring seal 126 compressed between a shoulder 55 (FIG. 4A) on seat ring 124 and an annular recess 52 (FIG. 4A) in segment 123a, b or c.

A valve ball 128 is rotatably retained within cartridge 123 and includes a bore 126a angled to direct flow between a selected pair of ports 122a, b and c, the selection being made by rotation of lever 130 through a valve stem 132 engaged at the rotational axis of valve ball 126.

If desired, a four-way ball valve (not shown) may be provided in accordance with the teachings of the present invention simply by increasing the number of cartridge members accordingly.

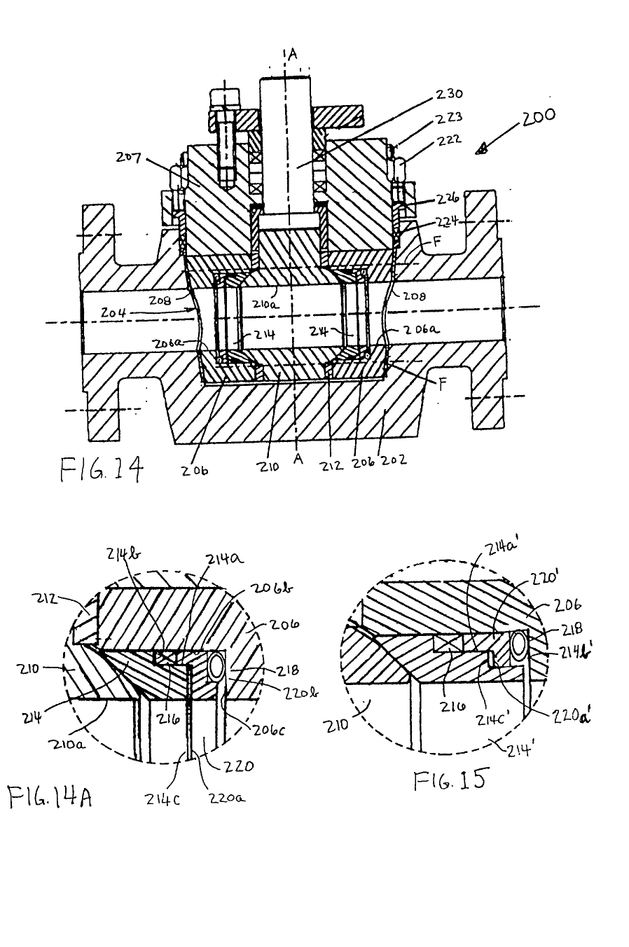

Referring to FIGS. 14 and 14A, there is shown a ball valve 200 which is particularly suited for operation at high pressures and temperatures (over 300° C.). The valve comprises a valve body 202 having a frustoconical cavity contiguously receiving a cartridge insert 204 of two tapered semicircular half-shells 206 joined at facing planar sides by four threaded fasteners (not shown) inserted along parallel center lines F-F and retained in valve body 202 by a bonnet 207. Ports 206a in respective half-shells 206 coaxially align in communication with the flow passage of valve body 202. Seals 208 bonded to the outer surfaces of half-shells 206 around the ports 206a provide a tight static seal between valve body 202 and cartridge insert 204.

Cartridge insert 204 contains a valve ball 210 journaled in upper and lower bushings 212 between opposed annular valve seats 214 for rotation on an axis A-A normal to the flow passage of valve body 202. A bore 210a through the valve ball axially aligns with opposed ports 206a when rotated 90° about axis A-A from a closed position to the open position shown.

As best seen in FIG. 14A, each valve seat 214 is slidable in an annular recess 206b around a respective port 206a and is urged against valve ball 210 in a controlled amount by the combined compression of an annular spring seal 216, mounted on a valve seat shoulder 214a, and an annular coil spring 218 between shoulders 206c and 214b of half-shell 206 and valve seat 214. A push ring 220 slidable on valve seat shoulder 214a is interposed between spring seal 216 and coil spring 218. The opposite sides of coils spring 218 make circular line contact with the facing surfaces 220b of push ring 220 and 206c of half-shell 206. The amount of compression contributed by coil spring 218 is limited by engagement of facing surfaces 214c and 220a of valve seat 214 and push ring 220, respectively. Seats 214 and seals 216 are preferably of the same materials as described in the ball valve of FIG. 1. Coil spring 218 is preferably made of a nickel-chromium-cobalt spring alloy having a stress-rupture and creep resistance to about 1700° F. (920° C.). A coil spring found suitable for the present application is made of Nimonic alloy 90® by Helicoflex Company/Cefilac Etancheite.

Whereas the cartridge assemblies of FIGS. 1 and 8 employ one spring seal at each valve seat, cartridge insert 204 employs a unique combination of a spring seals and coil spring for maintaining positive sealing at each valve ball-valve seat interface under extreme fluid temperatures and pressures. Compression by coil spring 218 is continuously applied against valve seat 214 with different rates of expansion and contraction and compensates for any wear between the contacting surfaces of valve seat 214 and valve ball 210. However, if the contraction or wear exceeds a predetermined limit, the force of coil spring 218 becomes ineffective.

Bonnet 207 and cartridge insert 204 are secured to valve body 202 by nuts 222 threadedly tightened on four corner studs 223 (two shown) extending from valve body 202. A bonnet ring seal 224, compressed between bonnet 207 and valve body 202 by gland follower 226 and packing screws 228, seals the interface. A valve stem 230 extends through bonnet 207 and interlocks with valve ball 210 for transmitting rotation about ball axis A-A. A thrust washer 232 and stem cover 234 acting against a shoulder in bonnet 207 sustains axial loading and restricts upward movement of valve stem 230. Valve stem 230 is sealed against leakage by conventional components such as disclosed for the valve stems in the embodiments of FIGS. 1 and 8.

Like the embodiments of FIGS. 1 and 8, cartridge insert 204 may be quickly and easily installed and removed without dismantling entire ball valve 200. The components are assembled essentially the same way but with the addition of push rings 220 and coil springs 218.

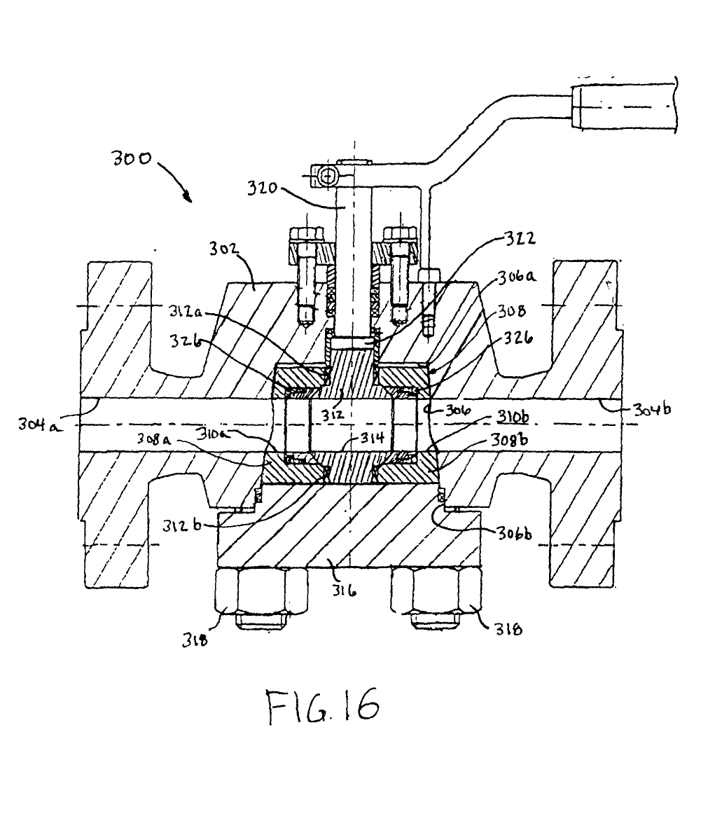

FIG. 15 shows another construction of the seal arrangement within the cartridge insert in which a valve seats 214′ each has a second annular shoulder 214b′ encircled by a push ring 220′ as it slides along a first shoulder 214a′. The degree of compression contributed by coil spring 218 is limited by the interfacing surfaces 214c′ and 220a′.

Referring now to FIG. 16, there is illustrated a ball valve 300 which allows the cartridge insert to be replaced without dismounting the valve activating mechanism or instrumentation system. A valve body 302 includes aligned inlet and outlet passages 304a and 304b communicating through a frustoconical cavity 306 which tapers outwardly from an annular boss 306a to a bottom entry opening 306b. A cartridge insert 308 received in opening 306b includes two joined half-shells 308a and 308b with respective ports 310a and 310b aligned with inlet and outlet passages 304a and 304b. Half-shells 308a and 308b include upper and lower journal bearings 312a and 312b which rotatably support a valve ball 312 between the half-shells on an axis normal to the length of passages 304a and 304b. A bore 314 through ball 312 aligns with ports 310a and 310b when rotated 90 degrees from a fully closed position to a fully open position as shown. Cartridge insert 308 is retained in sliding contact with cavity 306 by a bonnet 316 sealingly secured by fasteners 320 around the bottom entry opening 306b. A valve stem 318 extending through the top of valve body 302 engages a key slot 322 and is connected to a hand lever 324 for manually actuating valve 300. Composite coil spring seals 326 are of the same construction as the seals described in the embodiment of FIG. 15.

Some of the many advantages and novel features of the invention should now be readily apparent. For instance, ball valve construction is provided in which the plug and seal components are preassembled and totally enclosed within a cartridge insert for easy replacement or repair without dismantling the valve body from an installation. The cartridge insert maintains positive dynamic sealing by a unique arrangement of spring seals which are isolated from the valve body and are completely independent of the valve body. The cartridge insert may be readily replaced without dismantling the valve body from a fluid line and replaced separately without dismantling the actuating mechanism from the valve body. The materials of construction used in the spring seals enables the valve to operate continuously under sustained conditions of high temperatures and pressures.

While preferred embodiments of the invention have been described in detail, various modifications, alterations and changes may be made within the scope of the invention as defined in the appended claims.

What is claimed is:

1. A ball valve comprising:
a valve body with a central cavity communicating between inlet and outlet ports;
a cartridge insert having separable sections joined together in the cavity with bores coaxial with the inlet and outlet ports;
a valve ball with a through passage slidingly rotatable in said cartridge insert from a closed position to a fully open position between said bores;
seat ring means contained within said cartridge insert on respective opposite sides of said ball, each of said ring means forming with a respective bore an annular chamber with opposed ends around the circumference of said ring; and
annular elastic seals respectively compressed between said opposed ends for urging said seat ring means axially in dynamic sealing contact with said ball.

2. A ball valve according to claim 1 wherein said elastic seals are made of a resilient and fluid impervious material from a group consisting of high density graphite and silicone rubber.

3. A ball valve to claim 2 wherein said graphite has a precompressed density in a range of about 1.4 to about 2.2 g/cm³, and within said annular chamber, a compressed density in a range of about 0.9 to about 1.2 g/cm³.

4. A ball valve according to claim I wherein each of said seals includes:
fastener means operatively connected to engaging surfaces of said bonnet and said cartridge for removably securing said cartridge to said bonnet during insertion and removal from the cavity.

11. A ball valve according to claim 10 wherein said fastener means includes:
holes formed in said cartridge insert surface;
studs extending from said bonnet surface with a portion inserted in said holes, said portions having opposed grooves; and
pins inserted through said cartridge insert into said grooves for holding said studs in place.

12. A ball valve according to claim 10 wherein said fastener means includes:
a circular recess in said bonnet surface;
a circular boss with a circumferential groove extending from said cartridge surface insertable in said recess; and
set screws extending through said cartridge into said groove for holding said boss in said recess.

13. A ball valve according to claim 1 wherein said sections of said cartridge insert are mating half-shells secured together on either side of said valve ball forming a frustoconical shape.

14. A ball valve according to claim 1 wherein one of said sections of said cartridge insert is a semicircular segment secured in a matching recess in another of said sections to form a frustoconical shape.

15. A ball valve according to claim 1 further comprising:
a channel encircling a seat ring means and communicating with an interface of said seat ring means and said valve ball; and
a conduit extending through said cartridge to said channel for introducing a cleaning fluid.

16. A ball valve according to claim 1 wherein said cartridge insert includes a portion extending through a bottom opening of the cavity;
a pull nut threadingly engages said extender portion to secure said cartridge in the valve body; and
set screws extending through said pull nut into the valve body locks said pull nut in place.

17. A ball valve comprising:
a valve body with a central cavity communicating between inlet and outlet ports;
a cartridge insert having separable sections joined together in the cavity with bores coaxial with the inlet and outlet ports;
a valve ball with a through passage slidingly rotatable in said cartridge insert from a closed position to a fully open position between said bores;
a valve bonnet removably mounted on said valve body; and
fastener means operatively connected to engaging surfaces of said bonnet and said cartridge for removably securing said cartridge insert to said bonnet during insertion and removal from the cavity.

18. A ball valve according to claim 17 wherein said fastener means includes:
holes formed in said cartridge insert surface;
studs extending from said bonnet surface and aligned with said hole with a portion inserted in said holes, said portions having opposed grooves; and
pins inserted through said cartridge insert into said grooves for securing said studs in place.

19. A ball valve according to claim 17 wherein said fastener means includes:
a circular recess in said bonnet surface;
a circular boss with a circumferential groove extending from said cartridge insert surface insertable in said recess; and
set screws extending through said cartridge insert into said groove for holding said boss in said recess.

20. A cartridge insert for a ball valve having a central cavity communicating between inlet and outlet ports, said insert comprising:
separable sections joined together in the cavity with bores coaxial with the inlet and outlet ports;
a valve ball with a through passage rotatable in said sections from a closed position to a fully open position between said bores;
valve seat means contained within on respective opposite sides of said valve ball, each of said seat means forming with a respective bore an annular chamber defining opposed ends around the circumference of said seat;
annular elastic seals compressed between said ends for urging said seat ring means axially in dynamic contact with said ball.

21. A cartridge insert according to claim 20 where in each of said seals includes:
a first spring abutting one of said chamber adjacent to said valve ball;
a second spring abutting an opposite one of said chamber; and
a push ring interposed under compression between said first and second springs.

22. A cartridge insert according to claim 21 wherein said first springs are made of a resilient and fluid impervious material from a group consisting of high density graphite and silicone rubber.

23. A cartridge insert according to claim 21 wherein said second spring is an annular coil.

24. A cartridge insert according to claim 21 wherein said second spring is made of an alloy of nickel, chromium and cobalt.

25. A cartridge insert according to claim 21 wherein said second spring is an alloy of Nimonic 90®.

26. A cartridge inert according to claim 21 further comprising: means for limiting the compression of said springs.

27. A ball valve comprising:
a valve body with a central cavity communicating between inlet and outlet ports;
a cartridge insert having first and second sections joined together in the cavity with bores coaxial with the inlet and outlet ports, each of said bores having an inwardly facing first shoulder;
a valve ball including a through passage slidingly rotatable in said cartridge from a closed position to a fully open position between said bores;
valve seats disposed at respective opposite sides of said ball and said shoulders, each of said valve seats having an outwardly facing second shoulder axially spaced from said first shoulder to form an annular chamber;
a push ring between two annular springs respectively compressed within each of said chambers between said first and second shoulders for urging said seat rings in dynamic sealing contact with said ball.

28. A ball valve according to claim 27 wherein one of said springs is made of a resilient and fluid impervious material from a group consisting of high density graphite and silicone rubber.

29. A ball valve according to claim 27 wherein one of said springs is made of a nickel-chromium-cobalt alloy.

30. A ball valve according to claim 27 further comprising means for limiting the pressure applied to said valve seat.

31. A ball valve comprising:
a valve body having a ball element with a through bore;
a plurality of ball-receiving cartridge members removably mounted in said valve body with said ball element disposed therebetween, each of said cartridge members having a bore with an open end confronting said ball element and defined by a first radial seal shoulder spaced from said ball element and a cylindrical inner surface extending therefrom toward the ball element; and
a seal assembly carried by each cartridge member, said seal assembly including a tubular valve seat having a radial flange with a ball element engaging surface on one side and a second radial seal shoulder opposite said one side, said valve seat having a reduced diameter surface disposed in said cartridge bore and with said shoulders disposed in confronting relation forming a chamber, and a tubular seal element engaged between said shoulders and extending along said valve seat reduced diameter surface in said chamber, said seal element being formed of graphite and compressed between said shoulders when said cartridge members are secured together with said ball element operatively disposed therebetween.

32. A ball valve comprising:
a valve body having a ball element with a through bore;
a plurality of ball-receiving cartridge members removably mounted in said valve body with said ball element disposed therebetween, each cartridge member having a bore with an enlarged open end confronting the ball element and being defined by a first radial seal shoulder spaced from the ball element and a cylindrical inner surface extending therefrom toward the ball element;
a seal assembly carried by each cartridge member, said seal assembly including a tubular valve seat having a radial flange with a ball element engaging surface on one side and a second radial seal shoulder opposite said one side, said valve seat having a reduced diameter surface disposed in said cartridge bore and with said first and second seal shoulders disposed in confronting relation forming a chamber, and a tubular seal element engaged between said first and second seal shoulders and extending along said valve seat reduced diameter surface in said chamber, said seal element having a rectangular transverse cross-section formed of elastically-compressible expanded graphite, said seal element having a pre-compressed density in a range of about 0.9 to about 1.2 g/cm³ and being compressed between said shoulders to a density in a range of about 1.4 to about 2.2 g/cm³ when said cartridge members are secured together with the ball element operatively disposed therebetween.

33. A ball valve according to claim 17 further comprising:
positioning means for rotating said valve ball; and
an opening in said cavity at the side of said valve body proximal to said positioning means for receiving said cartridge insert.

34. A ball valve according to claim 17 further comprising:
positioning means for rotating said ball valve; and
an opening in said cavity on the side of said valve distal to said positioning means for receiving said cartridge.
